(19) United States
(12) Patent Application Publication
(10) Pub. No.: US 2026/0171779 A1
(43) Pub. Date: Jun. 18, 2026

(54) MODULAR CRYOGENIC INTERCONNECTS AND QUANTUM COMPUTING SYSTEMS

(71) Applicant: International Business Machines Corporation, Armonk, NY (US)

(72) Inventors: Ashutosh Rao, White Plains, NY (US); Stephen W. Bedell, Wappingers Falls, NY (US)

(21) Appl. No.: 18/980,200

(22) Filed: Dec. 13, 2024

(51) Int. Cl. H02G 15/34

(52) U.S. Cl. CPC H02G 15/34

(57) ABSTRACT

A system can include two or more cryogenic chambers, modularly connected via a cryogenic connector, wherein the connector forms a vacuum tight seal between the cryogenic chambers. The connector can comprise a fixed signal carrying member that connects a cryogenic signal carrying member within a first cryogenic chamber to a second signal carrying member in a second cryogenic chamber.

### TECHNICAL FIELD

The subject disclosure relates to modular cryogenic interconnects and quantum computing systems, e.g., operable isolation of various components.

### BACKGROUND

Development of superconducting quantum computers has made significant progress. However, a challenge in scaling quantum systems is limitation imposed by cooling capacity of dilution refrigerators, which are essential for maintaining ultra-low temperatures required for superconducting qubits to function. Inherent cooling limitations of such systems stem from finite capacity to dissipate heat, particularly as number of qubits grow and system(s) becomes more complex. Current strategies to mitigate this problem typically involve building larger dilution refrigerators, thereby expanding available cooling capacity. Another approach has been to implement a cryogenic microwave quantum interconnect using a superconducting cable to link multiple refrigerators within a shared vacuum space. While these methods represent steps toward larger quantum systems, they fall short of providing true modularity.

A drawback of existing approaches is their reliance on shared vacuum environments, which limits modularity and flexibility of the system. With such designs, any servicing that requires bringing part of the system up to room temperature necessitates venting an entire cryogenic environment, thereby disrupting operation of the entire quantum computing system, leading to increased system downtime and reducing overall reliability. Furthermore, constructing larger dilution refrigerators or linking them with cryogenic interconnects without addressing the issue of thermal and vacuum isolation makes it challenging to scale quantum computers efficiently. As the quantum computing landscape advances, there is a growing need for solutions that enable scaling without such constraints.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, methods, and/or structures that facilitate modular cryogenic interconnects in quantum computing systems.

According to an embodiment, a system can comprise two or more dilution refrigerators, modularly connected to one or more shared cryogenic interconnect hubs via cryogenic arms, wherein each of the two or more dilution refrigerators are operably isolated from the cryogenic interconnect hubs and from each other.

According to another embodiment, a method for preparing superconducting quantum computers for servicing can comprise modularly connecting two or more dilution refrigerators to one or more shared cryogenic interconnect hubs via cryogenic arms. The method can further comprise isolating each dilution refrigerator from the cryogenic interconnect hubs and from each other, and heating and venting at least one of the two or more dilution refrigerators in preparation for service.

According to yet another embodiment, a structure can comprise a cryogenic connector, wherein the connector forms a vacuum tight seal between at least two cryogenic chambers.

### BRIEF DESCRIPTION OF THE DRAWINGS

FIGS. 1-6 illustrate example systems that can facilitate modular cryogenic interconnects in quantum computing systems.

FIGS. 7-9 illustrate example structures that can facilitate modular cryogenic interconnects in quantum computing systems.

FIG. 10 illustrates an example modular cryogenic interconnects flow diagram in accordance with some embodiments described herein.

FIG. 11 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Superconducting quantum computers represent one of the most promising approaches to realizing scalable, fault-tolerant quantum computation. These systems rely on superconducting qubits, which must be maintained at temperatures close to absolute zero in order to take advantage of their quantum properties. Achieving and sustaining such ultra-low temperatures requires use of highly specialized cooling systems known as dilution refrigerators (“DRs”), which are capable of reaching millikelvin temperature ranges. However, as quantum computers grow in size and complexity—adding more qubits, control electronics, and interconnects—cooling demands on these refrigerators increase significantly. Limitations in cooling capacity have become a critical bottleneck in quest to scale up quantum computing systems. Each dilution refrigerator has a finite capacity to dissipate heat, a factor that constrains the number of components that can be integrated into a single cryogenic environment.

Dilution refrigerators operate by mixing two isotopes of helium, creating a phase transition that absorbs heat from the system and lowers its temperature. While this process is highly effective for small-scale quantum systems, it becomes increasingly difficult to manage as scale of the system grows. Larger quantum computers generate more heat, not only from qubits themselves but also from surrounding classical control hardware and interconnects. Additionally, wiring required to control qubits and read out their states generates heat as electrical signals pass through, adding to thermal load. To accommodate this increased thermal demand, one solution is to construct larger dilution refrigerators. Increasing volume of the refrigerator and enhancing its cooling power can create enough thermal headroom to support more qubits and associated electronics. However, there are practical and technical limits to scaling size of dilution refrigerators. The larger a system, the more difficult it becomes to manage heat distribution uniformly, and greater the complexity of internal layout of wiring and components needs to be, which can lead to further inefficiencies.

An alternative approach is to use cryogenic microwave quantum interconnects. These interconnects employ superconducting cables that link multiple dilution refrigerators together, allowing them to share cooling load across multiple units. Connecting refrigerators in this manner allows for distribution of qubits and their control hardware across multiple cryogenic environments, potentially increasing total number of qubits that can be operated concurrently. However, this approach is also limited by need to maintain a shared vacuum space between refrigerators. The requirement for a continuous vacuum environment means that any repair, maintenance, or upgrade that necessitates bringing part of the system up to room temperature requires venting an entire vacuum space and disrupting operation of the entire quantum computing system. This shared environment also means that a thermal issue in one part of the system can potentially affect the stability and reliability of other connected units.

While larger dilution refrigerators and cryogenic interconnects represent meaningful advancements, neither solution addresses the need for true modularity, which would allow for individual cryogenic environments to operate independently while being interconnected in a way that maintains thermal, vacuum, and electrical isolation. True modularity would enable portions of the system to be serviced or upgraded without impacting operation of the entire quantum computing system. Additionally, modularity would provide greater flexibility in system design, allowing for piecewise scaling, where new qubits or components could be added incrementally. Without need for a monolithic shared environment, a modular approach would also enhance reliability by isolating potential failures or thermal issues to specific modules rather than affecting the entire system. Such modularity is a critical next step in overcoming limitations imposed by current dilution refrigerator technology and in realizing truly scalable quantum computers.

In relation to scalability and efficiency of quantum computing systems, embodiments of the present disclosure produce a solution to one or more of these problems. These embodiments can solve such problems by modularly connecting two or more dilution refrigerators to one or more shared cryogenic interconnect hubs via cryogenic connectors, isolating each dilution refrigerator from the cryogenic interconnect hubs and from each other via the cryogenic connectors, and heating and venting at least one of the two or more dilution refrigerators in preparation for service.

According to an embodiment, a system can include a processor that executes computer executable components stored in memory. The system can further comprise two or more cryogenic chambers, modularly connected via a cryogenic connector, wherein the connector forms a vacuum tight seal between the cryogenic chambers.

In some embodiments, the connector can comprise a fixed signal carrying member that connects a cryogenic signal carrying member within a first cryogenic chamber to a second signal carrying member in a second cryogenic chamber. In various embodiments, the two or more cryogenic chambers can be dilution refrigerators.

In various embodiments, the cryogenic connector can enable vacuum isolation of two or more dilution refrigerators. The vacuum isolation can be achieved by using at least one of slide-on or snap-on or press-release connectors. The cryogenic connector can enable thermal isolation of respective refrigerators.

In some embodiment, the cryogenic connector can further comprise a superconducting cable or ribbon that electrically connects the two or more cryogenic chambers. The superconducting cable or ribbon can further comprise a horizontal actuator. The horizontal actuator can enable electrical isolation of a dilution refrigerator by making or breaking electrical connection between the dilution refrigerator and one or more shared cryogenic interconnect hubs.

In various embodiments, the cryogenic connector is insulated by a slab or structured composite of low microwave loss material. The cryogenic connector can be insulated by a slab or structured composite of low thermal conductivity material.

In some embodiments, the cryogenic connector can further comprise a cryogenic microwave quantum interconnect that uses a superconducting cable to connect the two or more cryogenic chambers. The cryogenic connector can operably isolate the two or more cryogenic chambers from each other. Operably isolating the two or more cryogenic chambers can further enable modular scalability of a cryogenic system.

Advantages of this system can include allowing for portions of the system to be serviced or upgraded independently, minimizing downtime and avoiding disruptions to the entire system. Advantages of this system can further include enhanced scalability by enabling piecewise expansion, where new qubits or components can be added incrementally as needed. Advantages can further include improved system reliability by preventing thermal or vacuum issues in one area from affecting the performance of the rest of the system. Furthermore, such a system can provide greater design flexibility, allowing for tailored configurations and growth without the constraints of a monolithic shared environment.

According to some embodiments, the above-described computer system can be implemented as a computer-implemented method or as a computer program product. According to some embodiments, a structure comprising a cryogenic connector, wherein the connector forms a vacuum tight seal between at least two cryogenic chambers, can be used to implement the above-described computer system.

Some embodiments of the present disclosure are now described with reference to the drawings. In the drawings, like referenced numerals are used to refer to like elements throughout. In the following description, for purposes of explanation, numerous specific details are set forth in order to provide a more thorough understanding of the embodiments. In various cases, some embodiments can be practiced without these specific details, yet a person having ordinary skill in the art will recognize that such embodiments are within metes and bounds of this disclosure.

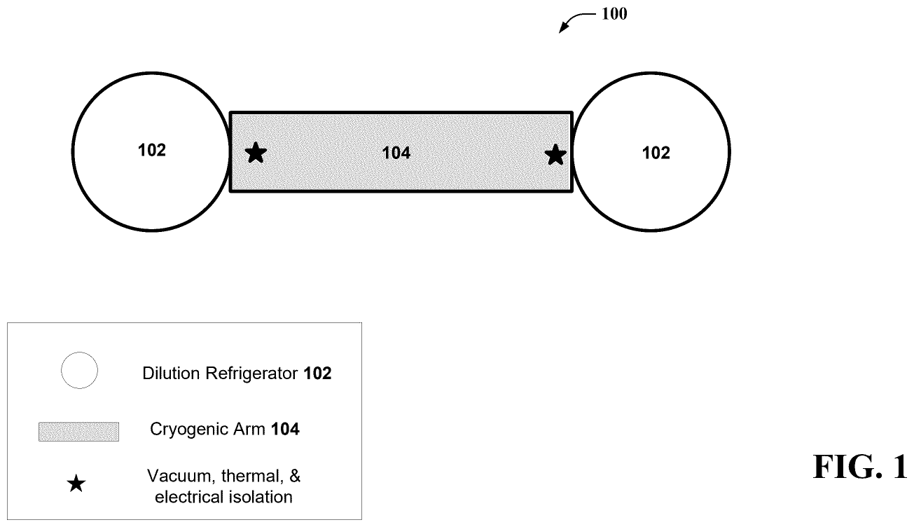

FIG. 1 illustrates an example system 100 for modular cryogenic interconnection in quantum computing systems. The system 100 uses two or more dilution refrigerators 102, modularly connected to one or more shared cryogenic interconnect hubs via cryogenic arms 104, wherein each of the two or more dilution refrigerators 102 are operably isolated from the cryogenic interconnect hubs and from each other.

Aspects of systems (e.g., systems 100, 200, and the like), apparatuses, or processes in various embodiments of the present disclosure can constitute one or more machine-executable components embodied within one or more machines. For example, the components can be embodied in one or more computer readable mediums (or media) associated with one or more machines. Such components, when executed by the one or more machines (e.g., computers, computing devices, virtual machines, etc.) can cause the machines to perform the operations described. System 100 can comprise two or more dilution refrigerators 102, modularly connected to one or more shared cryogenic interconnect hubs via cryogenic arms 104, a memory, a processor, and a system bus.

The system 100 and/or the components of the system 100 can use hardware and/or software to solve problems that are highly technical in nature. The system 100 solves problems that are not abstract and that cannot be performed as a set of mental acts by a human. Further, some of the processes can be performed by specialized computers for carrying out defined tasks related to modular cryogenic interconnection in quantum computing systems. The system 100 and/or components of the system 100 can be employed to solve new problems that arise through advancements in technologies. The system 100 can provide technical improvements to modular cryogenic interconnects in quantum computing systems by allowing for portions of the system to be serviced or upgraded independently, minimizing downtime and avoiding disruptions to the entire system, enhancing scalability by enabling piecewise expansion, and improving system reliability

The system 100 uses two or more dilution refrigerators 102. These refrigerators 102 can provide ultra-low temperatures necessary for superconducting qubits to function. Each dilution refrigerator 102 can operate independently, hosting its own set of qubits and associated hardware.

The system 100 can include a processor. In some embodiments, the processor can execute a component or subcomponent associated with the system 100. Components or subcomponents associated with the system 100 can include one or more machine readable, writable, and/or executable instructions. In some embodiments, the system 100 can include a memory, and the memory can store one or more components and/or subcomponents associated with the system 100. In some embodiments, the processor can execute a component stored in the memory.

In some embodiments, the system 100 can include a computer-readable memory that can be operably connected to the processor. The memory can store computer-executable instructions that, upon execution by the processor, can cause the processor and/or one or more other components of the system 100 (e.g., the dilution refrigerator 102, and/or the cryogenic arm 104) to perform one or more actions. In some embodiments, the memory can store computer-executable components.

The system 100 and/or a component thereof as described herein may be communicatively, electrically, operatively, optically, and/or otherwise coupled to one another via a bus. The bus may include one or more of a memory bus, memory controller, peripheral bus, external bus, local bus, and/or another type of bus that may employ one or more bus architectures. In some embodiments, the system 100 may be coupled (e.g., communicatively, electrically, operatively, optically, and/or the like) to one or more external systems (e.g., an electrical output production system, one or more output targets, an output target controller, and/or the like). In some embodiments, the system 100 may be coupled to one or more external sources, and/or devices (e.g., classical computing devices, communication devices, and/or like devices), such as via a network. In some embodiments, one or more of the components of the system 100 may reside in the cloud and/or locally in a local computing environment (e.g., at one or more specified locations).

In addition to the processor and/or the memory described above, the system 100 may include one or more computer and/or machine readable, writable, and/or executable components and/or instructions. When executed by the processor, these components and/or instructions may enable performance of one or more operations defined by the component(s) and/or instruction(s).

In some embodiments, the cryogenic arms 104 are respectively connected to the two or more dilution refrigerators 102 via respective joints. The respective joints can enable vacuum isolation of two or more dilution refrigerators. The vacuum isolation can be achieved by using at least one of slide-on or snap-on or press-release connectors. Each cryogenic arm joint can enable thermal isolation of respective refrigerators 102. Each cryogenic arm joint can be insulated by a slab or structured composite of low microwave loss material. Each cryogenic arm joint can be insulated by a slab or structured composite of low thermal conductivity material. The isolation provided by the joint can enable operation of the cryogenic arms and cryogenic interconnect hubs at either the same temperature as the dilution refrigerator or at temperatures higher than the dilution refrigerator.

According to some embodiments, each dilution refrigerator 102 can be electrically connected to the one or more shared cryogenic interconnect hubs via a superconducting cable or ribbon. The superconducting cable or ribbon can further comprise a horizontal actuator. The horizontal actuator can enable electrical isolation of a dilution refrigerator by making or breaking electrical connection between the dilution refrigerator and the one or more shared cryogenic interconnect hubs.

In some embodiments, the two or more dilution refrigerators 102 can be connected to one another via a cryogenic microwave quantum interconnect that uses a superconducting cable between two dilution refrigerators. The superconducting cable can pass through the one or more shared cryogenic interconnect hubs and cryogenic arms.

According to some embodiments, operably isolating the two or more dilution refrigerators 102 from the cryogenic interconnect hubs and from each further enables one or more portions of a cryogenic environment to be brought up to room temperature for servicing without venting the rest of the cryogenic environment. Operably isolating the two or more dilution refrigerators 102 from the cryogenic interconnect hubs and from each other can enable modular scalability of the system 100.

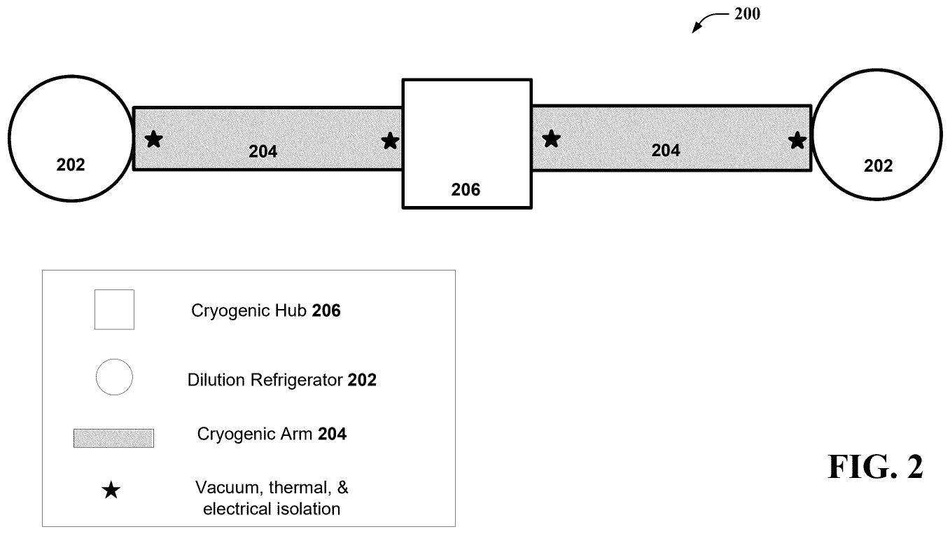

FIG. 2 illustrates an example system 200 that can facilitate modular cryogenic interconnection in quantum computing systems. The system 200 uses two or more dilution refrigerators 202, modularly connected to one or more shared cryogenic interconnect hubs 206 via cryogenic arms 204, wherein each of the two or more dilution refrigerators 202 are operably isolated from the cryogenic interconnect hubs 206 and from each other. Repeated description of like elements has been omitted for the sake of brevity. The one or more shared cryogenic interconnect hubs 206 can be used to link multiple cryogenic environments, such as dilution refrigerators 202, within a quantum computing environment. Cryogenic interconnect hubs 206 can further enable communication and data transfer between separate cryogenic modules or units while maintaining ultra-low temperature conditions required for superconducting qubits. This communication can be accomplished via microwave or optical signals. According to some embodiments, cryogenic interconnect hubs 206 can enable distribution of computational tasks across multiple refrigerators 202. Cryogenic interconnect hubs 206 can use superconducting cables to connect different cryogenic modules. For example, these cables can transmit quantum information (e.g., via microwave photons) between qubits located in separate refrigerators 202.

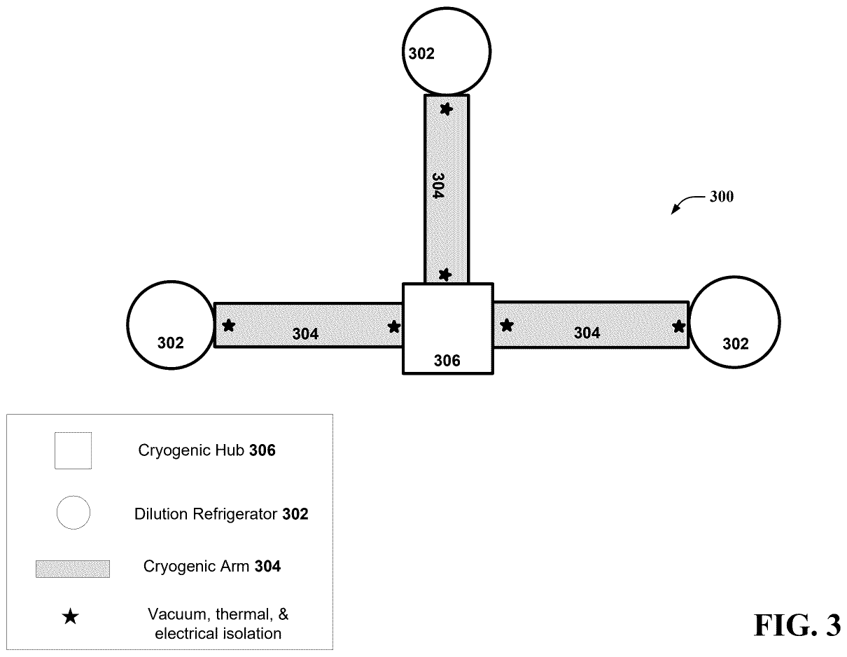

FIG. 3 illustrates an example system 300 that can facilitate modular cryogenic interconnection in quantum computing systems. The system 300 uses two or more dilution refrigerators 302, modularly connected to one or more shared cryogenic interconnect hubs 306 via cryogenic arms 304, wherein each of the two or more dilution refrigerators 302 are operably isolated from the cryogenic interconnect hubs 306 and from each other. Repeated description of like elements has been omitted for the sake of brevity.

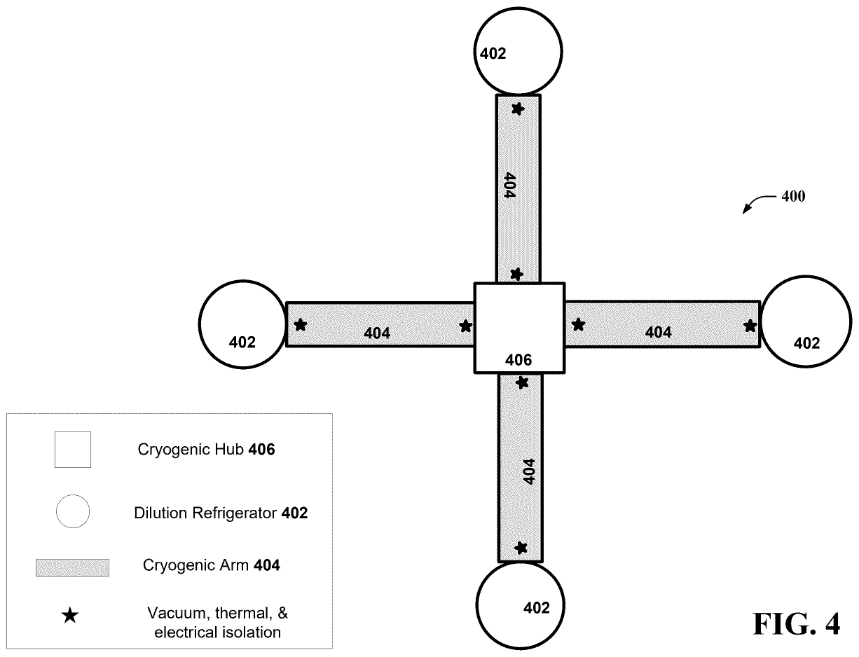

FIG. 4 illustrates an example system 400 that can facilitate modular cryogenic interconnection in quantum computing systems. The system 400 uses two or more dilution refrigerators 402, modularly connected to one or more shared cryogenic interconnect hubs 406 via cryogenic arms 404, wherein each of the two or more dilution refrigerators 402 are operably isolated from the cryogenic interconnect hubs 406 and from each other. Repeated description of like elements has been omitted for the sake of brevity.

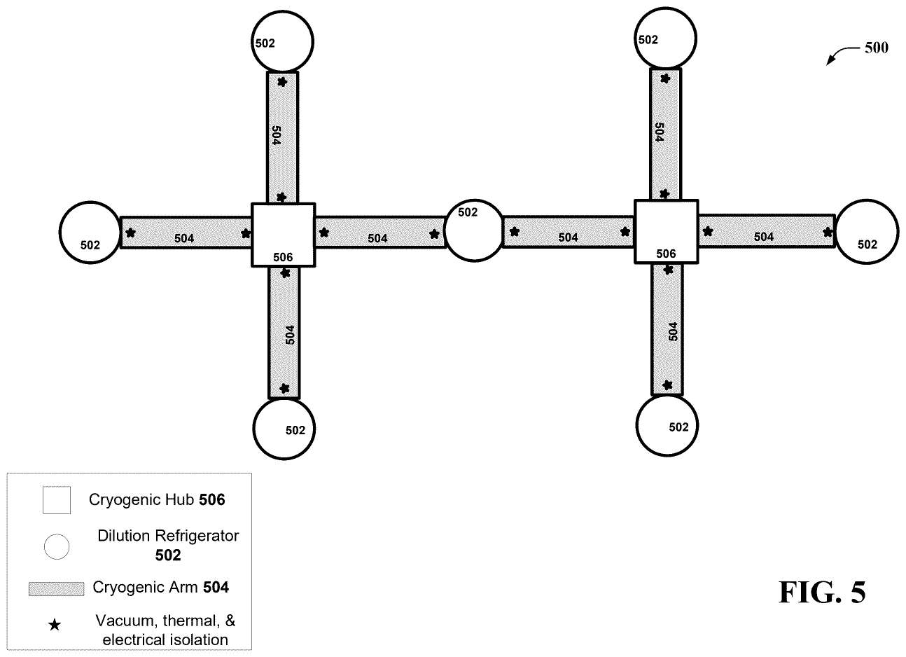

FIG. 5 illustrates an example system 500 that can facilitate modular cryogenic interconnection in quantum computing systems. The system 500 uses two or more dilution refrigerators 502, modularly connected to one or more shared cryogenic interconnect hubs 506 via cryogenic arms 504, wherein each of the two or more dilution refrigerators 502 are operably isolated from the cryogenic interconnect hubs 506 and from each other. Repeated description of like elements has been omitted for the sake of brevity.

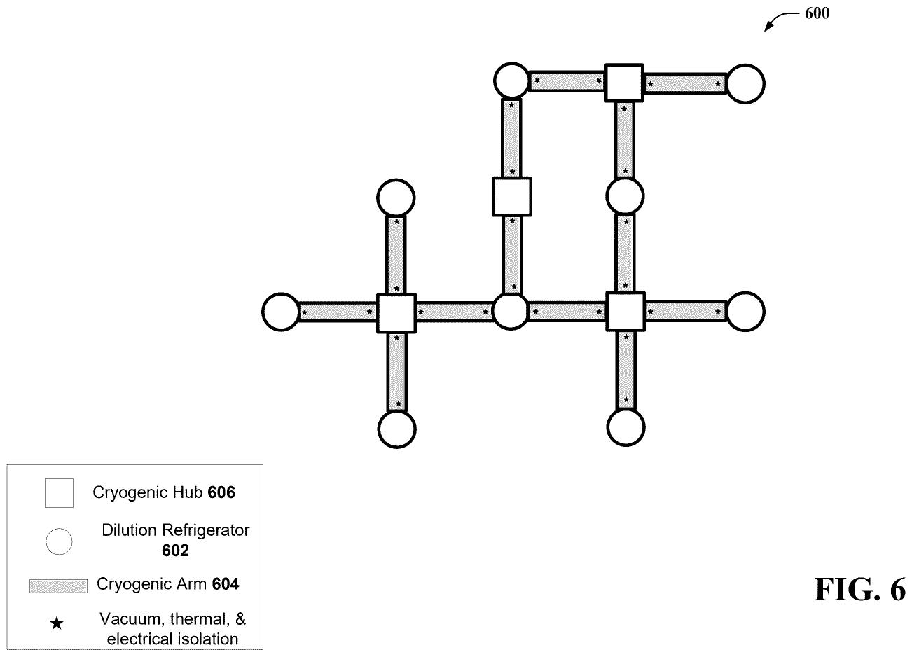

FIG. 6 illustrates an example system 600 that can facilitate modular cryogenic interconnection in quantum computing systems. The system 600 uses two or more dilution refrigerators 602, modularly connected to one or more shared cryogenic interconnect hubs 606 via cryogenic arms 604, wherein each of the two or more dilution refrigerators 602 are operably isolated from the cryogenic interconnect hubs 606 and from each other. Repeated description of like elements has been omitted for the sake of brevity.

FIGS. 1-6 illustrate that the systems described herein may consist of multiple dilution refrigerators, cryogenic interconnect hubs, and cryogenic arms, and therein represents a scalable architecture that overcomes many limitations of traditional quantum computing systems. By interconnecting multiple dilution refrigerators in a flexible, isolated, and modular manner, the systems described herein enable incremental growth/scaling without the need for large, monolithic cooling environments. In the systems described above, each dilution refrigerator can be thermally and vacuum-isolated from other refrigerators and from the cryogenic interconnect hub. This isolation can ensure that failures or service requirements in one refrigerator does not affect the others, thereby enhancing reliability and operational flexibility. Importantly, this independent operation allows for adding more dilution refrigerators in a modular fashion, each serving as a self-contained unit that integrates into the larger quantum computing system via a cryogenic hub. This flexibility further allows for potentially infinite conceivable configurations. The example configurations of FIGS. 1-6 are merely illustrative and are not intended to be limiting in any way. Rather, FIGS. 1-6 showcase that a network of cryogenic refrigerators and cryogenic hubs may be connected via cryogenic arms.

For example, multiple dilution refrigerators can be connected to a single shared cryogenic interconnect hub, each via a cryogenic arm. In this configuration, the hub can serve as a central communication and quantum entanglement management point. The system can be expanded by simply adding more refrigerators to the hub or by introducing additional hubs. As the system scales further, a network of interconnected hubs can be used. Each hub can manage a cluster of dilution refrigerators, and the hubs themselves can be connected to one another, creating a scalable, distributed network.

One of the key advantages of this modular approach is the ability to grow a system incrementally. As computing needs increase, additional dilution refrigerators can be added without disrupting the operation of existing units. Each new refrigerator can be integrated by connecting it to an existing hub via a cryogenic arm or by establishing a new hub. This avoids the need for large, monolithic expansion efforts, allowing for more agile, scalable growth. Furthermore, by distributing qubits and computational tasks across multiple dilution refrigerators, the overall system can benefit from a more balanced thermal load. Rather than relying on a single, large refrigerator to cool the entire system, each refrigerator can handle a portion of the load, improving cooling efficiency. Moreover, the isolated nature of each refrigerator can ensure that a failure in one unit (e.g., a qubit malfunction or a service issue) does not compromise the operation of the entire system. This isolation can be crucial for large-scale systems where downtime and reliability are major concerns.

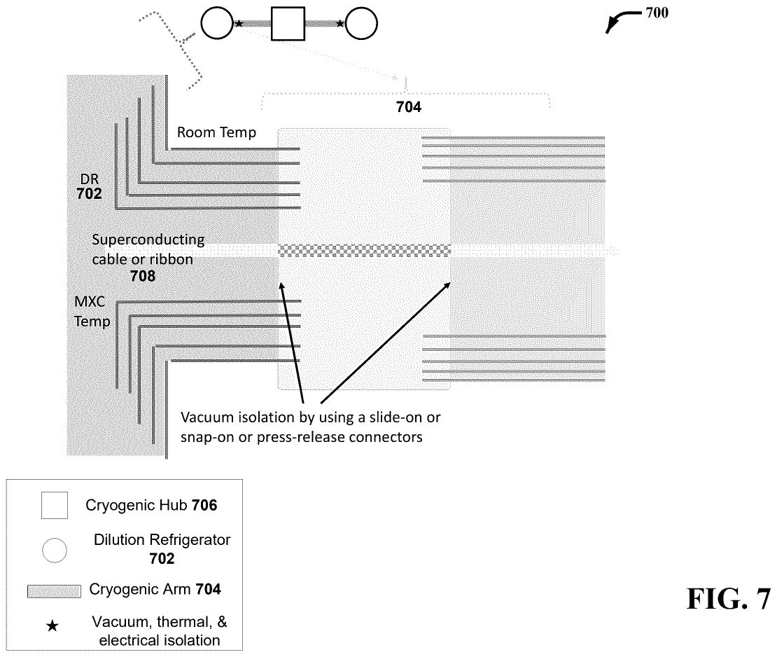

FIG. 7 illustrates an example structure that can facilitate modular cryogenic interconnection in quantum computing systems. The structure can comprise a cryogenic connector 700, wherein the connector forms a vacuum tight seal between at least two cryogenic chambers. According to an embodiment, the connector can comprise a fixed signal carrying member that connects a cryogenic signal carrying member within a first cryogenic chamber to a second signal carrying member in a second cryogenic chamber. In some embodiments, vacuum isolation may be achieved by using slide-on or snap-on connectors. Slide-on or snap-on connectors can be employed to achieve vacuum isolation between different cryogenic environments. These connectors can provide a practical, efficient way to link and decouple individual modules (e.g., dilution refrigerators, cryogenic arms, and interconnect hubs) while maintaining integrity of the vacuum and thermal isolation. Slide-on connectors can be specialized connectors designed to be pushed (or “slid”) into place to form a tight seal between two components. The slide-on connectors can feature precision-engineered mating surfaces that create a robust seal to maintain vacuum isolation. The slide-on connectors can further include internal gaskets or sealing rings to ensure vacuum seal once engaged. Snap-on connectors can be designed to “snap” into place with a locking mechanism, The snap-on connectors can use mechanical latching to apply consistent pressure to a sealing surface to maintain vacuum isolation. Superconducting cable or ribbon 708 can carry microwave signals with extremely low loss to connect different cryogenic modules. Superconducting cable or ribbon 708 can transmit quantum information (e.g., via microwave photons) between qubits located in separate refrigerators.

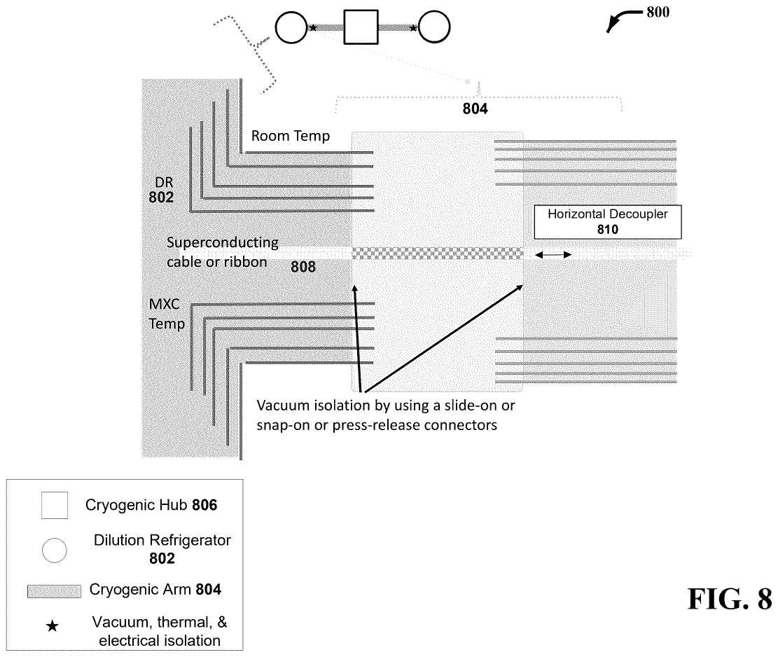

FIG. 8 illustrates an example structure 800 that can facilitate modular cryogenic interconnection in quantum computing systems. Repeated description of like elements has been omitted for the sake of brevity. Example structure 800 can be used to achieve both vacuum and electrical isolation. Horizontal decoupler 810 can be used to make or break an electrical connection. For example, if dilution refrigerator 802 needs to be heated and vented for servicing, electrical isolation can be achieved via the horizontal actuator 810 while preserving vacuum isolation.

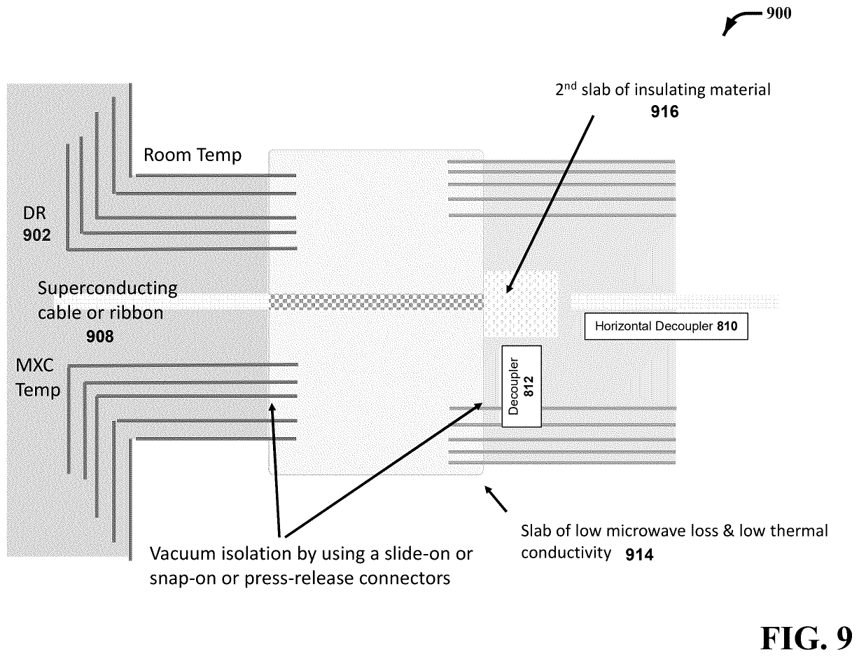

FIG. 9 illustrates an example structure 900 that can facilitate modular cryogenic interconnection in quantum computing systems. Repeated description of like elements has been omitted for the sake of brevity. Example structure 900 can be used to achieve vacuum, electrical, and thermal isolation. The second slab or structured composite of insulating material 916 can be as large as needed to provide enhanced insulation. Decouplers 910 and 912 can provide vertical and horizontal motion, similar to a slit-valve.

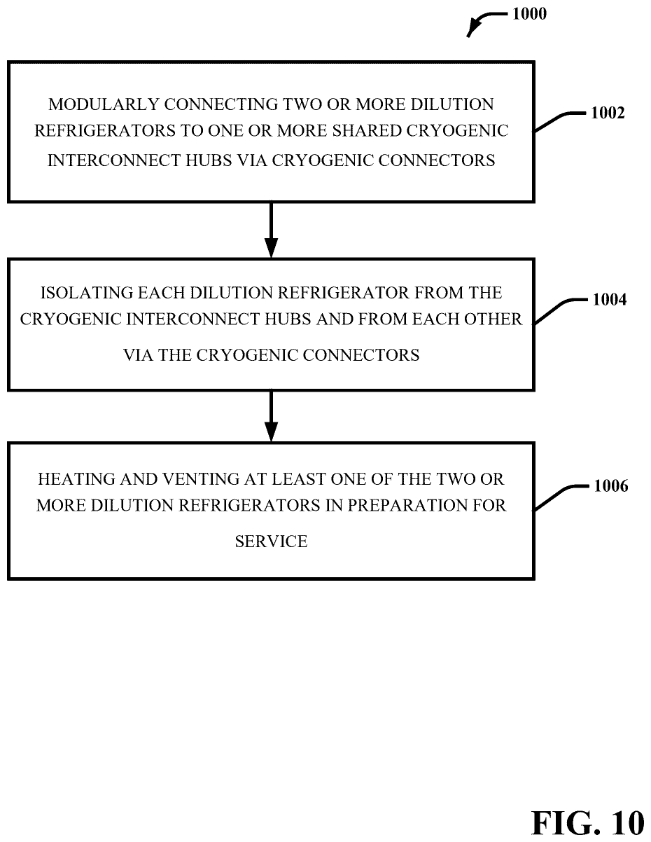

FIG. 10 illustrates a flow diagram of a method 1000 that can facilitate modular cryogenic interconnection in quantum computing systems. While the method 1000 is described relative to the system 200 of FIG. 2, the method 1000 can be applicable also to other systems described herein. Repetitive description of like elements and/or processes employed in respective embodiments is omitted for sake of brevity. The method 1000 can be used for preparing superconducting quantum computers for servicing.

At 1002, the method includes modularly connecting two or more dilution refrigerators (e.g., the dilution refrigerators 202) to one or more shared cryogenic interconnect hubs (e.g., the cryogenic interconnect hub 206) via cryogenic connectors (e.g., the cryogenic connector 700).

At 1004, the method includes isolating each dilution refrigerator from the cryogenic interconnect hubs and from each other via the cryogenic connectors.

At 1006, the method includes heating and venting at least one of the two or more dilution refrigerators in preparation for service.

According to some embodiments, the isolating can comprise at least one of thermal isolation, vacuum isolation, and electrical isolation. In some embodiment, the heating and venting of the at least one dilution refrigerator does not impact the temperature of any remaining dilution refrigerators. In other embodiments, the connector can further comprise a fixed signal carrying member that connects a cryogenic signal carrying member within a first cryogenic chamber to a second signal carrying member in a second cryogenic chamber.

In some embodiments, the method 1000 is performed by a system such as system 100 of FIG. 1 or system 200 of FIG. 2. The method 1000 can be a computer-implementable method. For simplicity of explanation, the methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

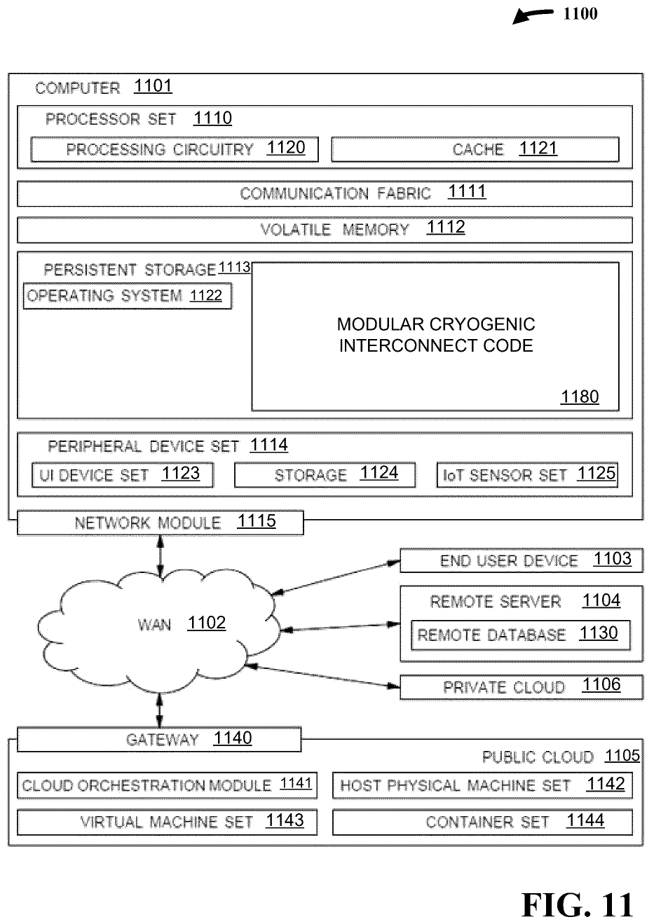

FIG. 11 and the following discussion are intended to provide a brief, general description of a suitable computing environment 1100 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as preparing superconducting quantum computers for servicing with modular cryogenic interconnect code 1180. In addition to block 1180, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1114 (including processing circuitry 1120 and cache 1121), communication fabric 1111, volatile memory 1112, persistent storage 1113 (including operating system 1122 and block 1145, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method can be distributed among multiple computers and/or between multiple locations. On the other hand, in this presentation of computing environment 1100, detailed discussion is focused on a single computer, specifically computer 1101, to keep the presentation as simple as possible. Computer 1101 can be located in a cloud, even though it is not shown in a cloud in FIG. 11. On the other hand, computer 1101 is not required to be in a cloud except to any extent as can be affirmatively indicated.

PROCESSOR SET 1110 includes one, or more, computer processors of any type now known or to be developed in the future. Processing circuitry 1120 can be distributed over multiple packages, for example, multiple, coordinated integrated circuit chips. Processing circuitry 1120 can implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set can be located “off chip.” In some computing environments, processor set 1110 can be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods can be stored in block 1145 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory can be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 can be a read only memory (ROM), but typically at least a portion of the persistent storage allows writing of data, deletion of data and re-writing of data. Some familiar forms of persistent storage include magnetic disks and solid-state storage devices. Operating system 1122 can take several forms, such as various known proprietary operating systems or open-source Portable Operating System Interface type operating systems that employ a kernel. The code included in block 1145 typically includes at least some of the computer code involved in performing the inventive methods.

PERIPHERAL DEVICE SET 1114 includes the set of peripheral devices of computer 1101. Data communication connections between the peripheral devices and the other components of computer 1101 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 can include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 can be persistent and/or volatile. In some embodiments, storage 1124 can take the form of a quantum computing storage device for storing data in the form of qubits. In embodiments where computer 1101 is required to have a large amount of storage (for example, where computer 1101 locally stores and manages a large database) then this storage can be provided by peripheral storage devices designed for storing large amounts of data, such as a storage area network (SAN) that is shared by multiple, geographically distributed computers. IoT sensor set 1125 is made up of sensors that can be used in Internet of Things applications. For example, one sensor can be a thermometer, and another sensor can be a motion detector.

NETWORK MODULE 1115 is the collection of computer software, hardware, and firmware that allows computer 1101 to communicate with other computers through WAN 1102. Network module 1115 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101) and can take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 can be a client device, such as thin client, heavy client, mainframe computer and/or desktop computer.

REMOTE SERVER 1104 is any computer system that serves at least some data and/or functionality to computer 1101. Remote server 1104 can be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data can be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs can be stored as images and can be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware and firmware allowing public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to some embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems, methods, and structures. It is, of course, not possible to describe every conceivable combination of components and/or methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
two or more cryogenic chambers, modularly connected via a cryogenic connector, wherein the connector forms a vacuum tight seal between the cryogenic chambers.

2. The system of claim 1, wherein the connector comprises a fixed signal carrying member that connects a cryogenic signal carrying member within a first cryogenic chamber to a second signal carrying member in a second cryogenic chamber.

3. The system of claim 1, wherein the two or more cryogenic chambers are dilution refrigerators.

4. The system of claim 3, wherein the cryogenic connector enables vacuum isolation of two or more dilution refrigerators.

5. The system of claim 4, wherein the vacuum isolation is achieved by using at least one of slide-on or snap-on or press-release connectors.

6. The system of claim 3, wherein the cryogenic connector enables thermal isolation of respective refrigerators.

7. The system of claim 1, wherein the cryogenic connector further comprises a superconducting cable or ribbon that electrically connects the two or more cryogenic chambers.

8. The system of claim 7, wherein the superconducting cable or ribbon further comprises a horizontal actuator.

9. The system of claim 8, wherein the horizontal actuator enables electrical isolation of a dilution refrigerator by making or breaking electrical connection between the dilution refrigerator and one or more shared cryogenic interconnect hubs.

10. The system of claim 1, wherein the cryogenic connector is insulated by a slab or structured composite of low microwave loss material.

11. The system of claim 1, wherein the cryogenic connector is insulated by a slab or structured composite of low thermal conductivity material.

12. The system of claim 1, wherein the cryogenic connector further comprises a cryogenic microwave quantum interconnect that uses a superconducting cable to connect the two or more cryogenic chambers.

13. The system of claim 1, wherein the cryogenic connector operably isolates the two or more cryogenic chambers from each other.

14. The system of claim 1, wherein operably isolating the two or more cryogenic chambers further enables modular scalability of a cryogenic system.

15. A structure, comprising:
a cryogenic connector, wherein the connector forms a vacuum tight seal between at least two cryogenic chambers.

16. The structure of claim 15, wherein the cryogenic connector comprises a fixed signal carrying member that connects a cryogenic signal carrying member within a first cryogenic chamber to a second signal carrying member in a second cryogenic chamber.

17. A method for preparing superconducting quantum computers for servicing, comprising:
modularly connecting two or more dilution refrigerators to one or more shared cryogenic interconnect hubs via cryogenic connectors;
isolating each dilution refrigerator from the cryogenic interconnect hubs and from each other via the cryogenic connectors;
heating and venting at least one of the two or more dilution refrigerators in preparation for service.

18. The method of claim 17, wherein the isolating comprises at least one of thermal isolation, vacuum isolation, and electrical isolation.

19. The method of claim 17, wherein the heating and venting of the at least one dilution refrigerator does not impact the temperature of the remaining dilution refrigerators.

20. The method of claim 17, wherein the connector comprises a fixed signal carrying member that connects a cryogenic signal carrying member within a first cryogenic chamber to a second signal carrying member in a second cryogenic chamber.
